(19) United States
(12) Patent Application Publication
(10) Pub. No.: US 2026/0348420 A1
(43) Pub. Date: Nov. 5, 2026

(54) SCREW-IN ELEMENT HAVING A LOCK AGAINST UNSCREWING, AND CORRESPONDING ASSEMBLY SYSTEM AND MANUFACTURING METHOD

(71) Applicant: MATHYS AG BETTLACH, Bettlach (CH)

(72) Inventors: Beat GRUNDER, Rüfenacht (CH); Gabriel TSCHUPP, Bellach (CH); Stefan SALADIN, Rumisberg (CH)

(21) Appl. No.: 19/478,454

(22) PCT Filed: Apr. 23, 2024
(86) PCT No.: PCT/IB2024/053963

§ 371 Date: Oct. 24, 2025

(30) Foreign Application Priority Data
Apr. 25, 2023 (DE) 10 2023 110 461.6

(51) Int. Cl. F16B 39/284

(52) U.S. Cl. CPC F16B 39/284

(57) ABSTRACT

The disclosure relates to a screw-in element 1 having a lock 2 against unscrewing, a system comprising the screw-in element 1 having a lock 2 against unscrewing, and an associated method for producing the screw-in element 1 having a lock 2 against unscrewing. The screw-in element 1 has a threaded body 3. The threaded body 3 has a thread 4. The screw-in element 1 has a lock 2 against unscrewing, wherein the lock 2 against unscrewing is molded onto the first end 5.

### CROSS-REFERENCE TO RELATED APPLICATIONS

This application claims priority to German Patent Application No. 10 2023 110 461.6, filed Apr. 25, 2023, which is hereby incorporated by reference herein in its entirety.

### FIELD OF THE DISCLOSURE

The disclosure relates to a screw-in element having a lock against unscrewing, an assembly system comprising the screw-in element having a lock against unscrewing, and a method for producing the screw-in element having a lock against unscrewing.

### BACKGROUND

The Austrian patent specification AT 61932 B shows a screw locking device, in which a clamping jaw is inserted into a recess of the nut. During the rotation of the nut in one direction, in a reverse rotation, the clamping jaw comes into locking engagement with the screw bolt. During a rotation in the other direction—a forward rotation—the screw bolt is released. A cross-section of the clamping jaw forms a right-angled triangle for this purpose. When the reverse rotation is initiated, the clamping jaw tilts such that a toothed tip of the triangle penetrates into the thread turns and thus achieves a locking effect.

A disadvantage of the screw locking device described above is the multipart design of the screw locking device. This multipart design results in a significant assembly effort. The increased assembly effort and the multipart design lead to an increased liability of the screw connection to fail. The multipart design can result in individual parts being lost during the product life cycle, i.e., during production, transport, installation, use, etc. In addition, the production of the clamping jaws comprising the recess provided in the screw bolt, and the assembly thereof, is complicated, and thus results in high manufacturing costs. The multipart design also has the disadvantage that the screw comprising the screw securing device is difficult to clean.

### Object and its Achievement

The disclosure therefore has the object of creating a screw-in element having a lock against unscrewing, an assembly system comprising a screw-in element having a lock against unscrewing, and a method for producing the screw-in element having a lock against unscrewing, which is provided with a lock against unscrewing at any screw depth and which can be produced with little effort.

The object is achieved by a screw-in element having a lock against unscrewing having the features of claim 1, an assembly system comprising the screw-in element having a lock against unscrewing having the features of claim 10, and an associated method for producing the screw-in element having a lock against unscrewing having the features of claim 12. The dependent claims referring thereto relate to advantageous developments.

### DETAILED DESCRIPTION OF THE DISCLOSURE

The screw-in element according to the disclosure contains a threaded body. The threaded body has a thread. The screw-in element has a lock against unscrewing, wherein the lock against unscrewing is molded onto the threaded body.

The screw-in element comprising the threaded body and the lock against unscrewing that is molded onto the first end of the threaded body particularly advantageously prevents or makes it more difficult, over the entire screw-in depth, to unscrew the screw-in element in an undesired manner. Furthermore, the molded-on lock against unscrewing significantly simplifies assembly, since the position of the lock against unscrewing is defined, and no individual components have to be assembled.

The spring element is preferably fixedly connected to the threaded body of the screw-in element at a first end, and a second end of the spring element is resiliently movable in the radial direction. In this way, a radial force is advantageously provided, which prevents or makes more difficult unintentional unscrewing.

The spring element is preferably bent in an annular, helical, or spiral shape. As a result of this embodiment of the spring element, a virtually constant force of the lock against unscrewing, in the direction of the contact with the receiving element, is particularly advantageously provided.

The spring element preferably has, at its first end, an outer radius which is at least 10% smaller, and particularly preferably an outer radius which is at least 5% smaller, in relation to a radius of a thread core of the threaded body. Further preferably, at its second end, the spring element has an outer radius which is at least 5% larger, and particularly preferably an outer radius which is at least 7% larger, in relation to a radius of a thread core of the threaded body. The spring element having such dimensions makes it possible, in a particularly advantageous manner, to insert and screw the screw-in element into the receiving element, without damaging a thread of the receiving element in the process.

Preferably, the spring element has, at its first end, an inner radius which is at least 10% larger, and particularly preferably an inner radius which is at least 5% larger, in relation to a radius of a thread diameter of the threaded body. Further preferably the spring element has, at its second end, an outer radius which is at least 5% larger, and particularly preferably an outer radius which is at least 7% larger, in relation to a radius of a threaded hole of the threaded body. Such a design of the spring element makes it possible, in a particularly advantageous manner, to insert and screw the screw-in element into the receiving element, without damaging a thread of the receiving element in the process.

The spring element of the screw-in element preferably has, at its second end, in a radial direction, a thickness which is at least 20% greater, more preferably a thickness which is 40% greater, and particularly preferably a thickness which is 50% greater. The greater material thickness at the second end is particularly advantageous, since the region of the spring element which is in contact with the counterpart receiving the screw-in element is deformed in a less elastic manner, such that a defined friction surface is made available.

The spring element preferably has an edge at its second end, which edge is designed to be in locking contact with a thread of a thread receiving the threaded body in the unscrewing direction. This edge particularly advantageously makes it more difficult to unscrew the screw-in element, even in the event of vibrations.

The lock against unscrewing of the screw-in element is preferably designed such that a torque for unscrewing the screw-in element is greater by a factor of 1.2, more preferably by a factor of 1.5, and particularly preferably by a factor of 5, in relation to a torque for screwing in the screw-in element. An unintentional unscrewing of the screw-in element is thus in a particularly advantageous manner prevented or made more difficult.

The screw-in element is preferably formed in one piece with the lock against unscrewing. A one-piece design of the screw-in element having the lock against unscrewing advantageously leads to an extremely reliable component which is also suitable for critical environments in which no foreign substances may be introduced.

The screw-in element is preferably connected to the lock against unscrewing by integral joining, and in particular by pressing, forging, plugging, soldering, or welding. The screw-in element can thus, particularly advantageously, be produced cost-effectively.

A further aspect of the disclosure relates to an assembly system for fastening the screw-in element—in particular, according to the preceding aspect of the disclosure—in a manner secured against unscrewing. The system comprises the screw-in element and a receiving element. The threaded element of the screw-in element and a threaded element of the receiving element are designed to form a screw connection. The lock against unscrewing of the screw-in element, and a threaded element of the receiving element are in contact in such a way that an unscrewing of the screw-in element from the receiving element is prevented or made more difficult.

The threaded element of the receiving element preferably has at least one notch which is designed to be in latching connection with the lock against unscrewing. The latching connection advantageously makes it more difficult to rotate the screw-in element in one direction.

A further aspect of the disclosure relates to a method for producing a screw-in element having a lock against unscrewing. The method has a step of molding the lock against unscrewing onto a threaded body of the screw-in element. Furthermore, the method has a step of creating a thread on the threaded body. In a particularly advantageous manner, the method according to the disclosure allows for cost-effective production of the screw-in element.

The step of molding on the lock against unscrewing, in the method for producing a screw-in element having a lock against unscrewing, is preferably achieved by machining, laser cutting, an erosion method, a soldering method, a welding method, hot deformation, and/or cold deformation, and preferably by forging, pressing, rolling, and/or punching.

### DESCRIPTION OF PREFERRED EMBODIMENTS

Exemplary embodiments of the disclosure are described by way of example below, with reference to the drawings, in which:

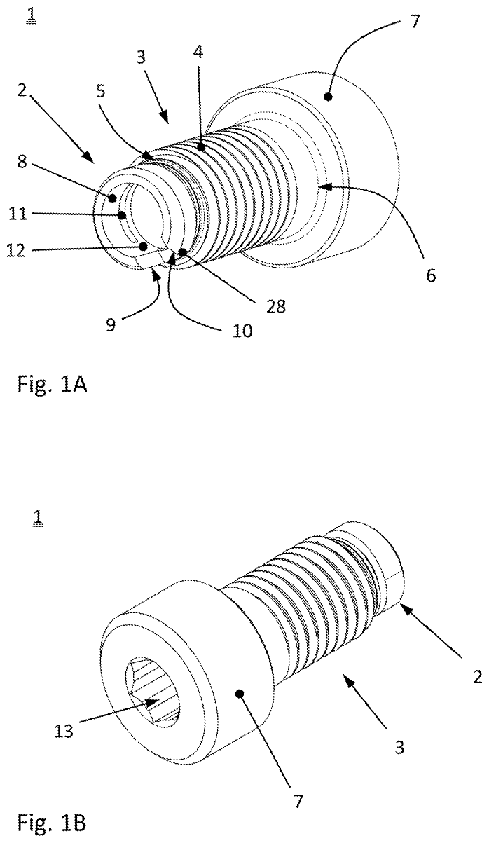

FIG. 1A is a perspectival view of an exemplary embodiment of a screw-in element according to the disclosure, with a view towards the lock against unscrewing;

FIG. 1B is a perspectival view of the exemplary embodiment of the screw-in element according to the disclosure, with a view towards a second end of the threaded body;

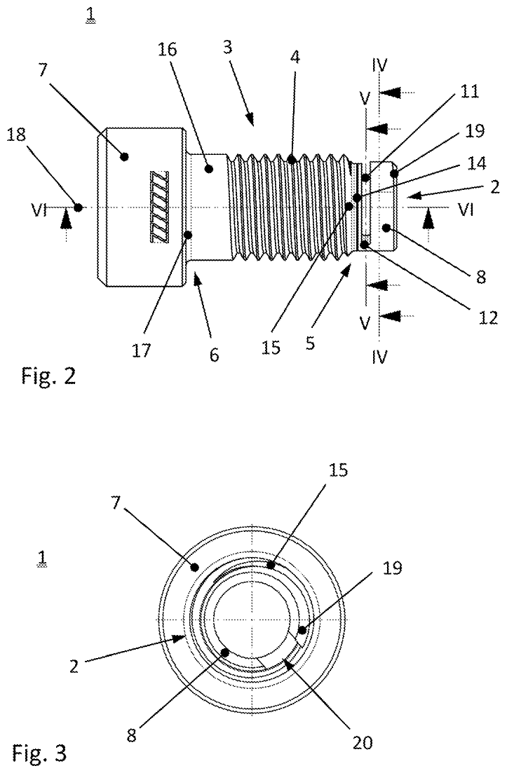

FIG. 2 is a side view of the exemplary embodiment of screw-in element according to the disclosure;

FIG. 3 is a front view of the exemplary embodiment of the screw-in element according to the disclosure;

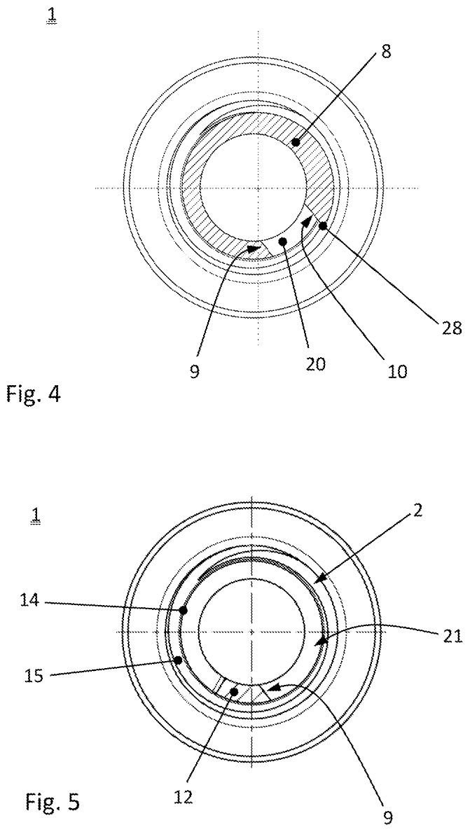

FIG. 4 is a sectional view of the exemplary embodiment of the screw-in element according to the disclosure, having a sectional plane perpendicular to the axis of rotation in the region of the spring element as part of the lock against unscrewing;

FIG. 5 is a sectional view of the exemplary embodiment of the screw-in element according to the disclosure, having a sectional plane perpendicular to the axis of rotation in the region of the web;

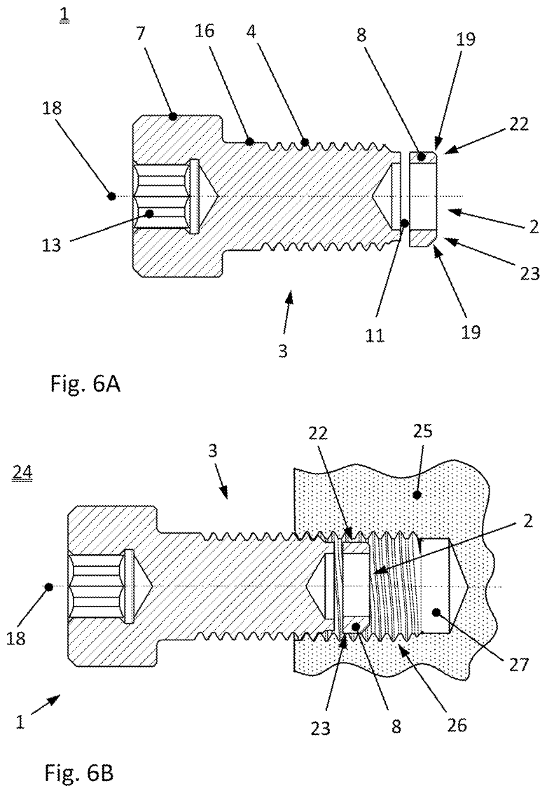

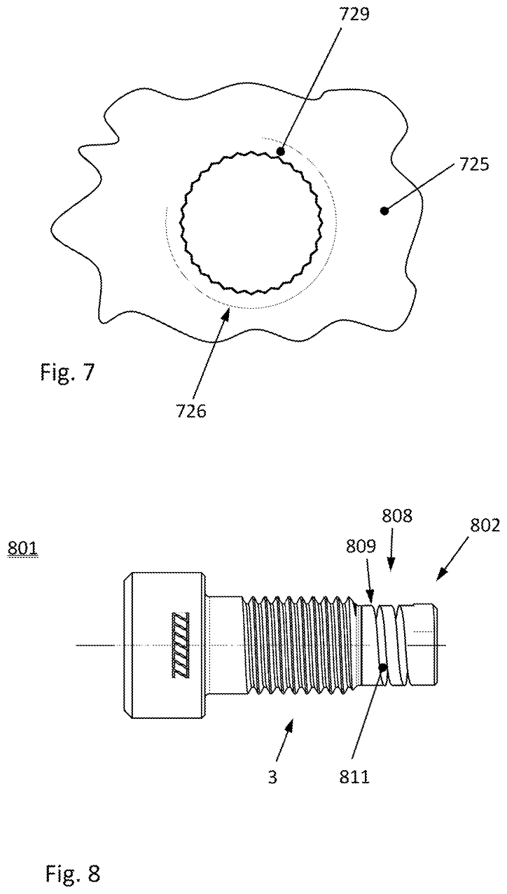

FIG. 6A is a sectional view of the exemplary embodiment of the screw-in element according to the disclosure, having a sectional plane along the axis of rotation;

FIG. 6B is a sectional view of an exemplary embodiment of a system according to the disclosure, having a sectional plane along the axis of rotation;

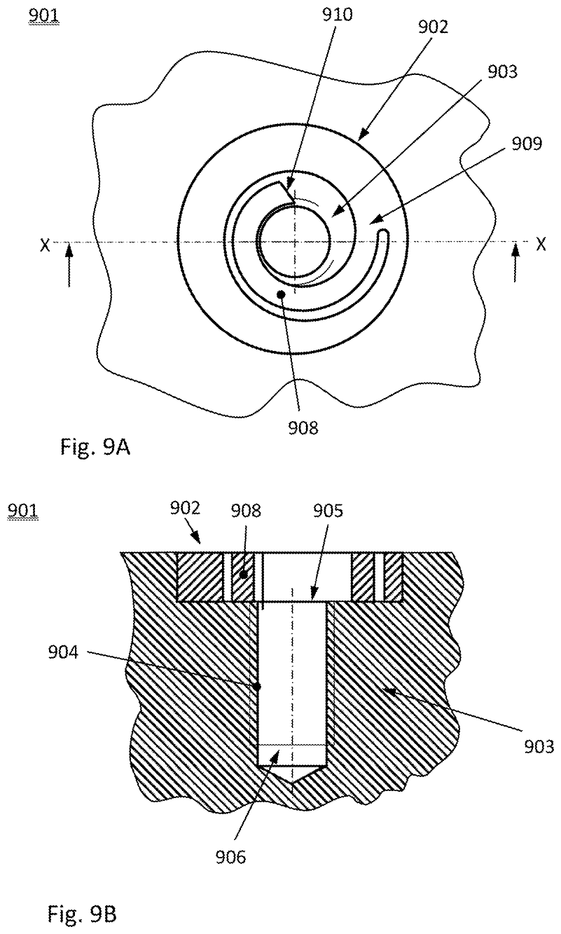

FIG. 7 shows an exemplary embodiment of a receiving element of the system according to the disclosure;

FIG. 8 shows an exemplary embodiment of a screw-in element according to the disclosure, having a helical spring element;

FIG. 9A is a plan view of an exemplary embodiment according to the disclosure of a screw-in element having an internal thread;

FIG. 9B is a sectional view of a side view of the exemplary embodiment according to the disclosure of the screw-in element having an internal thread;

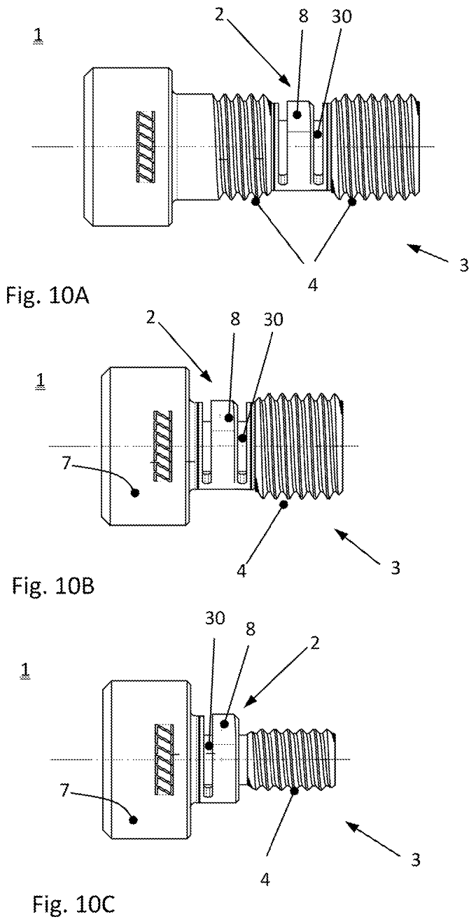

FIG. 10A is a side view of an exemplary embodiment of a screw-in element according to the disclosure, having a thread that is interrupted for receiving a lock against unscrewing;

FIG. 10B is a side view of an exemplary embodiment of a screw-in element according to the disclosure, having a lock against unscrewing that is arranged between the screw head and the thread element;

FIG. 10C is a side view of an exemplary embodiment of a screw-in element according to the disclosure, having a lock against unscrewing that is arranged between the screw head and the thread element and has an enlarged outer diameter; and

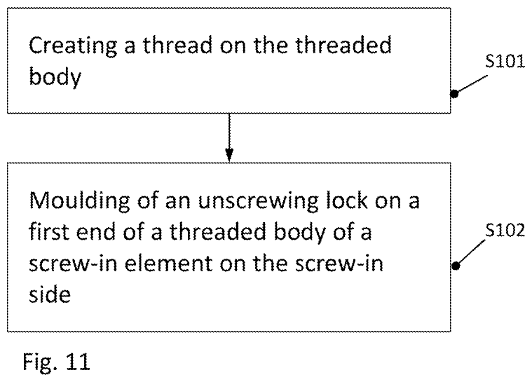

FIG. 11 shows a flowchart of the method according to the disclosure for producing a screw-in element.

FIGS. 1A and 1B are perspectival views of an exemplary embodiment of a screw-in element 1 according to the disclosure, having a lock 2 against unscrewing. The screw-in element 1 is shown here by way of example as a cylinder head screw.

As can be seen in the perspectival view of FIG. 1A, with a view towards the lock 2 against unscrewing, the screw-in element contains a threaded body 3. The threaded body 3 is substantially cylindrical. A thread 4 is molded onto the lateral surface of the threaded body 3. The threaded body has a first end 5 at the screw-in side, and a second end 6 opposite the first end, wherein the lock 2 against unscrewing is integrally formed on the first end 5.

In this exemplary embodiment, the lock 2 against unscrewing consists of an annular spring element 8. The spring element 8 is fixedly connected at its first end 9 to the first end 5 of the threaded body 3. The second end 10 of the spring element 8 is freely movable, in a resilient manner, in the radial direction with respect to the threaded body. A slot 11 is provided for this free, resilient mobility. This slot 11 separates the spring element 8 from the threaded body 3. The slot 11 extends from the second end 10 of the spring element 8 in the direction of the first end 9 of the spring element 8. A web 12 is provided, in order to connect the first end 9 of the spring element 8 to the first end 5, on the screw-in side, of the threaded body 3. In the exemplary embodiment, the web 12 extends over a circle segment of the annular spring element at an angle of 45° to 50°. Of course, other or several circle segments are also conceivable.

At its second end 10, the spring element 8 has an edge 28, on its side facing radially outwards, which is designed to be in locking contact with a thread of a thread receiving the thread body 3 in the unscrewing direction. With the aid of this edge 28, an increased torque is provided in the unscrewing direction, in relation to the screw-in torque. In the exemplary embodiment, the angle of the spring element 8 is less than 90° at the edge 28. The angle is designed in accordance with the required locking effect. An acute angle of between 60° and 80° leads to a large locking effect in the unscrewing direction, since the resulting edge hooks into the thread of the receiving element. An obtuse angle of between 95° and 100° results in a small locking effect in the unscrewing direction, which is based upon the friction between spring element 8 and the thread of the receiving element.

In further embodiments, the spring element 8 can have a thread-like structure on its surface which corresponds to the structure of the thread provided on the thread element 3. This thread-like structure increases the contact surface of the spring element and thus also an effective torque of the lock 2 against unscrewing.

The screw-in element 1 consists, for example, of metal—preferably of a steel—or of plastic. Depending upon the application, various types of steel are provided. For purely mechanical applications, the screw-in element 1 can consist of a spring steel having high tensile strength. In the medical field, and in particular for implants, a material is provided for the screw-in element that consists for example of a cobalt-chromium-molybdenum alloy (CoCrMo alloy), a CoCrNiMo alloy, a CrNiMo alloy, a brass, a bronze, an aluminum alloy, a titanium alloy, or a ceramic material such as an aluminum oxide, a zirconium dioxide, or a composite ceramic. In further applications, such as for the chemical industry, plastics are also provided. Reinforced PA, PEEK, PTFE, or carbon materials are conceivable.

FIG. 1B shows the exemplary embodiment of the screw-in element 1 with a view in the direction of a second end 6 of the threaded body 3. As can be seen, a cylindrical screw head 7 is molded onto the second end 6 of the threaded body 3 opposite the first end 5 on the screw-in side. In this exemplary embodiment, a hexagon socket 13 is provided for driving the screw-in element 1. Elements of any shape can be molded onto the second end of the threaded body 3. Furthermore, in addition to the screw head, described with regard to the exemplary embodiment, having the hexagon socket, any other screw head shape and drive form, such as external hexagon, countersunk head with hexalobular internal (TORX), lens head with cross-slit, etc., are conceivable. Furthermore, depending upon the application, any desired further shapes, such as spheres, cylinders, truncated cones, handwheels, etc., are conceivable.

FIG. 2 is a side view of the exemplary embodiment of the screw-in element 1 according to the disclosure. The threaded body 3 of the screw-in element 1 is substantially cylindrical. In this case, the threaded body has at least four portions.

A first portion of the threaded body 3 is a connection portion 14. The connection portion 14 is intended for providing a connecting transition of the threaded body 3, at its first end 5 on the screw-in side, to the lock 2 against unscrewing. This connection portion 14 is a cylindrical extension of the threaded body 3, which is dimensioned in its length such that the lock against unscrewing can be molded on without machining of the thread 4. In this exemplary embodiment, the diameter of the connection portion is 1% to 2% smaller than the core diameter of the thread.

A second portion of the threaded body 3 is a thread inlet portion 15. The thread inlet portion 15 provides a region which enables a resistance-free engagement of the thread 4 provided in the threaded body 3 into an associated thread of a receiving element. The thread inlet portion 15 is a conical extension of the diameter of the connection portion 14 to an outer diameter of the thread 4. The angle of the conical extension relative to an axis of rotation 18 is designed such that it is equal to the angle of one thread flank with respect to the axis of rotation 18.

A third portion of the threaded body 3 is the thread 4. The length of the thread is dependent upon specifications of a screw connection in which the screw-in element 1 is inserted. The thread 4 is defined by nominal diameter, pitch, and geometry. In this case, in this exemplary embodiment, the nominal diameter corresponds to the outer diameter of the thread 4. The thread 4 can be designed as a normal thread or a fine thread according to the metric system or inch system. The thread can furthermore be designed as a flat thread, round thread, saw thread, sharp thread, trapezoidal thread, Whitworth thread, multi-turn thread, etc. The thread shape and the measuring system of the thread 4 are not limited to the forms described above. The thread can have any suitable geometry.

A fourth portion of the threaded body is a shank 16. In this exemplary embodiment, the shank 16 is designed to be cylindrical. The diameter of the shank 16 corresponds to the outer diameter of the thread. In further embodiments, the shank 16 can have a conical design. In further embodiments, the shank 16 can have a smaller diameter than the nominal diameter of the thread 4. The geometry and dimensions of the shank 16 are not limited to the shape and dimensions described for this exemplary embodiment. In principle, the screw-in element 1 according to the disclosure can also be designed without a shank 16.

A screw head 7 is provided in the extension to the fourth portion of the threaded body 3—the shank 16. The transition between the screw head 7 and shank 16 has a radius-shaped fillet 17. The transition from the shank 16 to the screw head 7 through this fillet 17 considerably increases the strength of the screw-in element 1. This type of transition prevents damage to the screw-in element by a notch effect of an angular transition.

The design of the screw-in element 1 is not limited to the forms described above. In further exemplary embodiments, the screw-in element is also conceivable in the form of a grub screw, a threaded pin, etc. The grub screw according to an exemplary embodiment according to the disclosure contains a threaded body and a lock against unscrewing. In order to drive the grub screw, a drive receptacle is provided in the second end of the threaded body opposite the first end on the screw-in side. A hexagon socket, a hexalobular internal (TORX), a cross-slit, etc., is conceivable as the drive receptacle. In the further embodiment of the screw-in element 1 according to the disclosure as a threaded pin, a shank is provided, in addition to the embodiment according to the grub screw.

FIG. 2 further shows the lock 2 against unscrewing which is molded onto the first end 5 of the threaded body 3 via its connection portion 14. In the exemplary embodiment shown in FIG. 2, the slot 11 of the lock 2 against unscrewing is arranged perpendicularly to the axis of rotation 18. Via this slot 11, the spring element 8 is partially separated from the threaded body 3, and in particular from the connection portion 14 of the threaded body. The web 12 connects the spring element 8 to the first end 5 of the threaded body 3 on the screw-in side. The spring element 8 has a slip chamfer 19. This slip chamfer 19 is designed to enable the spring element 8 to be inserted into the threaded hole of the receiving element. For this purpose, in the exemplary embodiment, the slip chamfer 19 has an angle of 45° with respect to the axis of rotation 18.

FIG. 3 is a front view of the screw-in element 1, with a representation of the lock 2 against unscrewing. The screw-in element 2 is oriented in FIG. 3 such that the axis of rotation extends perpendicularly to the plane of the drawing, and the first end on the screw-in side faces towards the observer.

As already described, the lock 2 against unscrewing comprises the spring element 8, which is bent in an annular manner. The slip chamfer 19 is arranged on the end face of the spring element 8. The slip chamfer 19 is a peripheral bevel along the outer edge, facing the screw-in direction, of the spring element.

FIG. 3 further shows that the annular shape of the spring element 8 is interrupted by a spring opening 20. In this exemplary embodiment, the spring opening 20 is a recess which extends radially. This recess is introduced into the spring element 8 in such a way that the lateral walls, which in each case correspond to the first end 9 of the spring element 8 and the second end 10 of the spring element 8, extend in parallel in the radial direction. In this exemplary embodiment, the spring element 8 has a wall thickness which increases in the clockwise direction. For this purpose, the spring element 8 has, at its second end 10, in a radial direction, a thickness which is at least 20% greater, preferably a thickness which is 40% greater, and particularly preferably a thickness which is 50% greater, in relation to its first end 9.

The spring element 8 is connected to the thread inlet portion 15 via the transition portion (not representable here). The thread inlet portion 15 is provided in order that the thread (not shown here) of the screw-in element 1 be able to engage in the thread of the receiving element (not shown here). The thread follows the shank which connects the thread (neither shown here) to the screw head 7.

FIG. 4 is a sectional view of the exemplary embodiment of the screw-in element 1 according to the disclosure. The sectional plane extends perpendicularly to the axis of rotation in the region of the spring element 8, as part of the lock 2 against unscrewing. In FIG. 4, the annular shape of the spring element 8 comprising the spring opening 20 is once again illustrated by the hatched surface. The spring opening 20, in the form of the recess, is introduced into the spring element 8 in such a way that the lateral walls, which in each case correspond to the first end 9 of the spring element 8 and the second end 10 of the spring element 8, extend in parallel in the radial direction. The wall thickness of the spring element 8 increases towards the second end 10 thereof, clockwise, in the radial direction by at least 20%, preferably at least 40%, and particularly preferably by at least 50%, in relation to the first end 9.

At its second end 10, the spring element 8 has an edge 28, on the side facing the thread of the receiving element, which is designed to be in locking contact with a thread of a thread receiving the thread body 3 in the unscrewing direction. With the aid of this edge 28, an increased torque is provided in the unscrewing direction, in relation to the screw-in torque. In the exemplary embodiment, the angle of the spring element 8 at the edge 28 is less than 90°. Such an acute angle at the edge 28 makes it possible to hook the spring element 8 with the thread of the receiving element.

FIG. 5 is a sectional view of the exemplary embodiment of the screw-in element 1 according to the disclosure. The sectional plane extends perpendicularly to the axis of rotation in the region of the web 12. The slot made in the lock 2 against unscrewing, which is shown in the direction of the slot flank 21 assigned to the end 5 of the threaded body 3 on the screw-in side in FIG. 5, extends in the direction of the first end 9 of the spring element 8. At the end of the slot 11—in this case shown by the slot flank 21—the web 12 is provided, which connects the first end 9 of the spring element 8 to the first end 5 of the threaded body 3 on the screw-in side. The web 12 extends over a circle segment of the annular spring element 8—for example, at an angle of 45° to 50°. This circle segment is preferably designed such that the spring force acting upon the web 12 is absorbed by the web and is introduced into the threaded body 3. The web 12 is preferably further designed such that it can be neither plastically deformed nor damaged by this force.

FIG. 6A is a sectional view of the exemplary embodiment of the screw-in element 1 according to the disclosure. The sectional plane extends along the axis of rotation 18. The screw-in element 1 comprising the screw head 7, the shank 16, the threaded body 3, and the lock 2 against unscrewing is designed in one piece in this exemplary embodiment. The threaded body 3 is substantially cylindrical. The thread 4, the profile of which is shown in serrated form in FIG. 6A, is molded onto the lateral surface of the threaded body 3. As can be seen in this representation, the spring element 8 has a smaller outer radius in the region 22 shown at the top, in relation to the radius of the thread core of the threaded body 3. In the region 23 shown at the bottom, the spring element has a larger outer radius in relation to the radius of the thread core of the threaded body 3. This position of the spring element 2 is the rest state when the screw-in element 1 is not screwed in.

FIG. 6B is a sectional view of an exemplary embodiment of a system 24 according to the disclosure which comprises the screw-in element 1 and a receiving element 25. The screw-in element 1 is shown in a screwed-in state. As shown in FIG. 6B, the sectional plane extends along the axis of rotation 18.

The screw-in element 1 is screwed with its thread element 3 into a thread element 26 of the receiving element 25, so that a screw connection is formed. The lock 2 against unscrewing of the screw-in element 1, and the thread element 26 of the receiving element 25 are partially in contact in the screwed-in state. In this case, the region of the spring element 8 having a smaller outer radius in relation to a radius of a thread core of the threaded body 3—the region 22 of the spring element 8 shown at the top—is not in contact with the thread element 26 of the receiving element 25. The region having the larger outer radius in relation to the radius of the thread core of the threaded body 3—the region 23 of the spring element 8 shown at the bottom—is in contact with the thread element 26 of the receiving element 25.

As shown in FIG. 6B, the width of the spring element 8 of the lock 2 against unscrewing is dimensioned such that, at each region in its periphery, it is in contact with at least 2 tooth flanks of the thread of the thread element 26 of the receiving element 25. This prevents the spring element from bending or even breaking when the screw-in element 1 is rotated. In addition, an unintentional hooking of the screw-in element 1 into the receiving element is prevented.

In this exemplary embodiment, the thread element 26 is provided in a blind bore 27. The blind bore 27 extends in axial extension relative to the thread element 26 such that a thread of the thread element 26 can be formed, for example, using a tap drill. The blind hole formed in this way particularly advantageously ensures that a lock 2 against unscrewing, which is broken, for example, by mechanical damage, or a part thereof, is securely held in the region of the screw connection. This is advantageous especially in medical applications such as screw connections of implant components. In particular, in this case, an introduction of foreign material, such as screw parts, can lead to tissue damage and/or damage to the implant, which is avoided by such a screw connection.

The already described region of the spring element 8 having the larger cross-section, i.e., the region 23 of the spring element 8 shown at the bottom in FIG. 6B, is deflected perpendicularly to the axis of rotation 18. As a result of this deflection, the spring element 8 presses with its spring force against the thread element 26 of the receiving element 25. The contact between spring element 8 and thread element 26 of the receiving element 25, with the spring force resulting therefrom, provides friction which increases a torque for unscrewing. This torque for unscrewing the screw-in element 1 is designed such that it is greater by a factor of 1.2, preferably by a factor of 1.5, and particularly preferably by a factor of 5, in relation to a torque for screwing in the screw-in element.

FIG. 7 shows an exemplary embodiment of a receiving element 725 of the system for fastening a screw-in element 1 in a manner secured against unscrewing. The receiving element 725 contains a thread element 726, which has at least one notch 729. In the exemplary embodiment shown, a plurality of notches 729 are provided.

The notches 729 are designed to be in latching connection with the lock 2 against unscrewing. The notches 729 are further designed such that the edge 28 of the spring element 8 engages in the at least one notch 729. The spring element 8 that is bent in an annular, helical, or spiral-shaped manner results in an increased torque in one direction of rotation. This increased torque is generated when the direction of rotation of the screw-in element is initiated such that the spring element 8 widens. A widening of the spring element 8 takes place when the direction of rotation is introduced in the direction from the second end 10 of the spring element 8 towards the first end 9 of the spring element. Due to the widening of the spring element 8, the spring element 8 latches with its edge 28 in one of the notches 729 or the at least one notch.

The notches 729 can have different shapes depending upon the required latching effect. In addition to the triangular shape shown in the exemplary embodiment that has a uniform angle, sawtooth-shaped notches, rectangular notches, and wave-shaped notches are also conceivable. If the notch 729 and the latching tooth are designed asymmetrically in sawtooth shape, the factor for the release moment can be variably adjusted via the tooth flank angle, up to a non-releasable connection.

In an exemplary embodiment according to the disclosure, the receiving element 725 can consist of a material which enables a surface penetration of the edge 28 of the spring element 8. A metal, such as an aluminum alloy or a brass, or a plastic, for example, is provided as the material for the receiving element. In this case, the receiving element 725 is designed such that the penetration of the edge 28 of the spring element 8 generates a notch 729. Such a self-notching design allows a non-releasable screw connection. In addition, this screw connection advantageously provides security against tampering, since, in the event of an attempt to release the screw connection, the thread element 726 of the receiving element 725 is damaged. This makes it possible to detect a tampering attempt.

FIG. 8 shows a further exemplary embodiment of a screw-in element 801 having a lock 2 against unscrewing. In this exemplary embodiment, the lock 2 against unscrewing has a helical spring element 808. The helical spring element 808 is fixedly connected at its first end 809 to the first end 5 of the threaded body 3. The second end (not shown here) of the spring element 808 is freely movable in a resilient manner in the radial direction, relative to the threaded body. A helical slot 811 is provided for this free, resilient mobility.

The helical spring element 808 is designed such that it generates a low additional torque during screwing in. The spring element 808 is further designed such that a torque for unscrewing the screw-in element is greater by a factor of 1.2, preferably by a factor of 1.5, and particularly preferably by a factor of 5, in relation to a torque for screwing in the screw-in element.

At its second end (not shown here), the spring element 808 has an edge on the side facing the thread of the receiving element, which edge is designed to be in locking contact with a thread receiving the thread body 3 in the unscrewing direction. With the aid of this edge, an increased torque is provided in the unscrewing direction, in relation to the screwing-in torque.

FIG. 9A and FIG. 9B are a plan view and, in an associated sectional view, a side view of an exemplary embodiment according to the disclosure of a screw-in element 901 having an internal thread. The screw-in element 901 has a threaded body 903. The threaded body 903 has a thread 904, a first end 905 on the screw-in side, and a second end 906 opposite the first end. The screw-in element 901 further has a lock 902 against unscrewing, wherein the lock 902 against unscrewing is molded onto the first end 905.

FIG. 9A shows an exemplary embodiment of a lock 902 against unscrewing, which has a spiral spring element 908 in a flat shape. The spring element 908 can also be designed to be annular. The spring element 908 is fixedly connected, at a first end 909, to the first end 905 of the threaded body 903. A second end 910 of the spring element 908 is provided so as to be resiliently movable in the radial direction.

The inner radius of the spring element 908 is designed such that this inner radius is in the range between the radius of the core hole 906 of the thread 904 and nominal diameter of the thread 904. The inner radius of the spring element 908 may also have a radius which is smaller than the radius of the core hole 906 of the thread 904. In this case, the spring element 908 of the lock 902 against unscrewing of the screw-in element 901, and the thread element of the receiving element are in contact in such a way that unscrewing of the screw-in element 901 from the receiving element is made more difficult and/or prevented.

The threads 4, 904 provided in the screw-in elements 1 are shown as right-hand threads, according to the exemplary embodiments described above. The orientation of the threads is not limited to a right-hand thread. In further embodiments, left-hand threads are also conceivable. In this case, the orientation of the lock 2, 802, 902 against unscrewing is adapted in accordance with the screw-in direction specified by the thread twist in such a way that the torque for unscrewing the screw-in element 1, 801, 901 is greater by a factor of 1.2, preferably by a factor of 1.5, and particularly preferably by a factor of 5, in relation to a torque for screwing in the screw-in element 1, 801, 901.

FIG. 10A is a side view of an exemplary embodiment of a screw-in element 1 according to the disclosure, having a thread 4 that is interrupted for receiving a lock 2 against unscrewing. The thread 4 of the thread element 3 is interrupted in two thread segments. The threaded segments are connected to one another by a connecting element 30 in a tension-proof and torque-proof manner. The connection element 30 penetrates the lock 2 against unscrewing, in the axial direction. The diameter of the connection element 30 is designed such that the spring element 8 is also resiliently movable, in the radial direction, in the screwed-in state.

FIG. 10B is a side view of an exemplary embodiment of a screw-in element 1 according to the disclosure having a lock against unscrewing arranged between the screw head 7 and the thread element 3. The screw head 7 and the thread element 3 are connected to one another in a tension-proof and torque-proof manner by means of a connection element 30. The connection element 30 penetrates the lock 2 against unscrewing, in the axial direction. The diameter of the connection element 30 is designed such that the spring element 8 is also resiliently movable, in the radial direction, in the screwed-in state.

FIG. 10C is a side view of an exemplary embodiment of a screw-in element 1 according to the disclosure having a lock 2 against unscrewing which is arranged between the screw head 7 and the thread element 3 and has an enlarged outer diameter. As already described with reference to FIG. 10B, the screw head 7 and thread element 3 are connected to one another by a connection element 30 in a tension-proof and torque-proof manner. In order to increase the strength, in this exemplary embodiment, the connection element 30 has a diameter corresponding to the core diameter of the thread 4. The diameter of the connection element 30 is not limited to the described dimension, and can be adapted to requirements in terms of strength and space requirements. In this case, the diameter of the connection element 30 is designed in such a way that the spring element 8 is also resiliently movable, in the radial direction, in the screwed-in state. In further embodiments, the diameter of the connection element 30 and the dimensions of the lock 2 against unscrewing can be adapted to specifications such as torque and space requirements.

FIG. 11 shows a flowchart of the method according to the disclosure for producing a screw-in element. In a first method step S101, a thread is created on the threaded body. The thread can be created on the threaded body by rolling, machining, eroding, or laser machining.

In a further method step S102, the lock against unscrewing is molded onto a first end, on the screw-in side, of a threaded body of the screw-in element. The lock against unscrewing can be molded on by machining, laser cutting, an erosion method, a soldering method, a welding method, hot deformation, and/or a cold deformation, and preferably by forging, pressing, rolling, and/or punching.

1.-14. (canceled)

15. A screw-in element comprising:
a threaded body having a thread; and
a lock against unscrewing molded onto the threaded body and comprising a spring element;
wherein a first end of the spring element is fixedly connected to the threaded body, and a second end of the spring element is resiliently movable in the radial direction; and
wherein the spring element has, at the second end, an edge configured to be in locking contact with a thread receiving the threaded body in the unscrewing direction.

16. The screw-in element of claim 15, wherein the spring element is curved in an annular, helical, or spiral shape.

17. The screw-in element of claim 16,
wherein the spring element has, at the first end, an outer radius at least 5% smaller, in relation to a radius of a thread core of the threaded body, and
wherein the spring element has, at the second end, an outer radius at least 7% larger, in relation to the radius of the thread core of the threaded body.

18. The screw-in element of claim 16,
wherein the spring element has, at the first end, an inner radius which is at least 5% larger, in relation to a radius of a threaded hole of the threaded body, and
wherein the spring element has, at the second end, an inner radius which is at least 7% smaller, in relation to the radius of the threaded hole of the threaded body.

19. The screw-in element of claim 16, wherein the spring element has, at the second end, in a radial direction, a thickness at least 20% greater.

20. The screw-in element of claim 15, wherein the lock against unscrewing has a torque for unscrewing the screw-in element that is greater by a factor of 1.2 when compared to a torque for screwing in the screw-in element.

21. The screw-in element of claim 15, wherein the screw-in element is formed in one piece with the lock against unscrewing.

22. The screw-in element of claim 15, wherein the screw-in element is connected to the lock against unscrewing by pressing, forging, plugging, soldering, or welding.

23. An assembly system for fastening the screw-in element of claim 17 in a manner secured against unscrewing, wherein the assembly system comprises the screw-in element and a receiving element, wherein a threaded element of the screw-in element, and a threaded element of the receiving element are configured to form a screw connection, and wherein the lock against unscrewing of the screw-in element, and the threaded element of the receiving element are in contact in such a way that an unscrewing of the screw-in element from the receiving element is prevented or made more difficult.

24. The assembly system of claim 23, wherein the threaded element of the receiving element has at least one notch configured to be in latching connection with the lock against unscrewing.

25. A method for producing the screw-in element of claim 15, the method comprising:
forming the lock against unscrewing on the threaded body of the screw-in element; and
creating a thread on the threaded body.

26. The method of claim 25, wherein the forming the lock against unscrewing takes place by machining, laser cutting, an erosion method, a soldering method, a welding method, hot deformation, cold deformation, forging, pressing, rolling, punching, or any combination thereof.

27. A screw-in element comprising:
a threaded body having a thread;
a lock against unscrewing molded onto the threaded body and comprising a spring element;
wherein a first end of the spring element is fixedly connected to the threaded body, and a second end of the spring element is resiliently movable in the radial direction.

28. The screw-in element of clam 27, wherein the spring element is curved in an annular, helical, or spiral shape.

29. The screw-in element of claim 27, wherein the spring element has, at the second end, in a radial direction, a thickness which is at least 20% greater.

30. The screw-in element of claim 27, wherein the spring element has, at the second end, an edge configured to be in locking contact with a thread of a thread receiving the threaded body in the unscrewing direction.

31. The screw-in element of claim 27, wherein the lock against unscrewing has a torque for unscrewing the screw-in element that is greater by a factor of 1.2 when compared to a torque for screwing in the screw-in element.

32. The screw-in element of claim 27, wherein the spring element has, at the second end, an edge configured to be in locking contact with a thread receiving the threaded body in the unscrewing direction.

33. The screw-in element of claim 27,
wherein at the first end, an outer radius at least 5% smaller, in relation to a radius of a thread core of the threaded body, and
wherein the spring element has, at the second end, an outer radius at least 7% larger, in relation to the radius of the thread core of the threaded body.

34. An assembly system for fastening the screw-in element of claim 27 in a manner secured against unscrewing, wherein the assembly system comprises the screw-in element and a receiving element, wherein a threaded element of the screw-in element, and a threaded element of the receiving element are configured to form a screw connection, and wherein the lock against unscrewing of the screw-in element, and the threaded element of the receiving element are in contact in such a way that an unscrewing of the screw-in element from the receiving element is prevented or made more difficult, and wherein the threaded element of the receiving element has at least one notch configured to be in latching connection with the lock against unscrewing.
